(19) United States
(12) Patent Application Publication
(10) Pub. No.: US 2009/0216588 A1
(43) Pub. Date: Aug. 27, 2009

(54) RETURN ON INVESTMENT ANALYZER

(76) Inventors: Brian Coyne, Bradenton, FL (US); Trajan Bayly, New Haven, CT (US); Scott E. Wiley, Bradenton, FL (US)

Correspondence Address: General Electric Company;GE Global Patent Operation, PO Box 861, 2 Corporate Drive, Suite 648, Shelton, CT, 06484, US

(21) Appl. No.: 12/183,338

(22) Filed: Jul. 31, 2008

Related U.S. Application Data
(60) Provisional application No. 61/031,251, filed on Feb. 25, 2008.

(51) Int. Cl. G06Q 10/00

(52) U.S. Cl. 705/7

(57) ABSTRACT

In various embodiments, a user enters information regarding a business entity for classification of the business entity. Thereafter, a user views a series of questions and when those questions are pre-populated with answers a user can keep the pre-populated answer or replace the pre-populated answer with a different answer. The data submitted by the user can be transmitted towards a server (for subsequent updating of the populated answers in the server) and/or analyzed using the populated answers to determine a return on investment of equipment prior to purchasing equipment; and/or for an analysis of the business entity's current equipment. Embodiments of the invention also include other methods, computer-readable mediums, apparatuses, and systems that contain features similar to the features in the above described method.

### CROSS-REFERENCE TO RELATED APPLICATIONS

This application claims priority from U.S. provisional patent application Ser. No. 61/031,251, filed Feb. 25, 2008, which is incorporated by reference herein.

### BACKGROUND OF THE INVENTION

### Field of the Invention

Embodiments of the present invention generally relate to a return on investment and more particularly, to methods, computer-readable mediums, apparatuses, and systems for forecasting the return on investment of equipment prior to purchasing the equipment.

### SUMMARY

Aspects of this disclosure include but are not limited to, quantifying a return on investment of equipment prior to purchasing the equipment. For exemplary purposes only, the equipment is described herein as security equipment. In various embodiments, a user enters information regarding a business entity for classification of the business entity. Thereafter, a user views a series of questions and when those questions are populated with answers a user can keep the populated answer or replace the populated answer with a different answer. The data submitted by the user can be transmitted towards a server (for subsequent updating of the populated answers in the server) and/or analyzed using the populated answers to determine a return on investment of equipment prior to purchasing equipment; or for an analysis of the business entity's current equipment.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of an embodiment of a system in accordance with aspects disclosed herein.

FIG. 2 depicts an illustrative embodiment of a method in accordance with aspects disclosed herein.

FIG. 3 depicts another embodiment of a method in accordance with aspects disclosed herein.

FIG. 4 depicts a computer screen shot of a loss analysis derived from a combination of the populated answers and answers replaced on behalf of the business entity in accordance with aspects disclosed herein.

FIG. 5 depicts a high-level block diagram of a general-purpose computer architecture for performing aspects disclosed herein.

To facilitate understanding, identical reference numerals have been used, wherever possible, to designate identical elements that are common to the figures.

### DETAILED DESCRIPTION

In the following description, numerous specific details are set forth to provide a more thorough understanding of the invention. As will be apparent to those skilled in the art, however, various changes using different configurations may be made without departing from the scope of the invention. In other instances, well-known features have not been described in order to avoid obscuring the invention. Thus, the invention is not considered limited to the particular illustrative embodiments shown in the specification and all such alternate embodiments are intended to be included in the scope of this invention.

In general questions are selected and used to determine what are potential areas that financially impact business entities as it related to the business needs (e.g., security). Aspects disclosed herein quantify (i.e., justifies) the savings to a business entity.

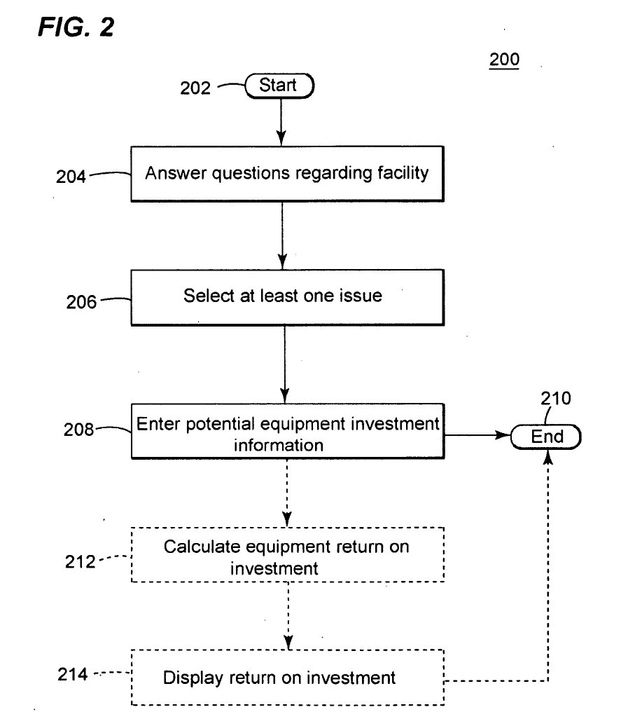

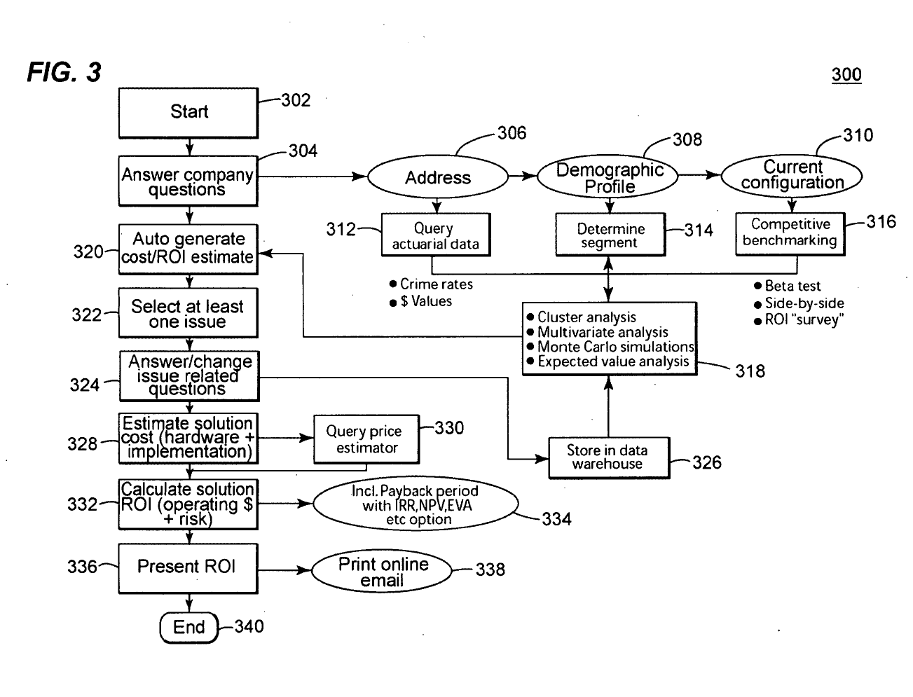

Tables 1-14 depict exemplary questions and the resulting return-on-investment analysis in accordance with the exemplary methods described below and depicted in FIGS. 2 and 3.

In various embodiments, a stand-alone personal computer (e.g., a laptop computer, a desktop computer, or a personal data assistant (“p.d.a.”) etc.) is utilized in accordance with aspects of this disclosure. The stand-alone computer has an internal memory having stored thereon questions pre-populated with answers from other clients. The pre-populated answers were acquired from other clients. When data, for a current client, is entered (and questions are answered) into the stand-alone computer regarding a current client (e.g., the current client's classification; the current client's hardware configuration; inserting an answer(s) (or by a lack thereof accepting a current answer(s) as also applicable to the current client); and/or prioritization of the current client's needs), the data from the other clients is utilized to analyze the data provided by the current client. In various embodiments, results of the analysis are output in the form of a spreadsheet.

In other embodiments, a server is included (described in greater detail below). Although aspects disclosed herein are described which utilize a server those descriptions are not intended in any way to limit the scope of the invention. For example, the exemplary information contained in Tables 1-14 can also be utilized in a stand-alone personal computer (i.e., a computer not connected to another server/computer).

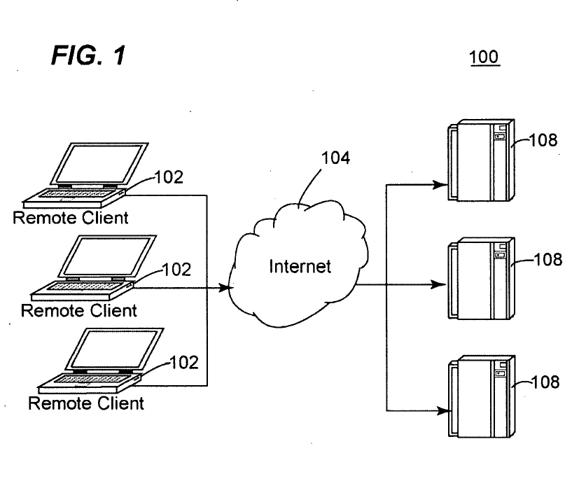

FIG. 1 depicts a block diagram of an embodiment of a system 100 in accordance with aspects disclosed herein. The system 100 includes at least one server 108 (illustratively depicted as three servers 108), at least one remote client 102 (illustratively depicted as three remote clients 102), and a network connection 104 (e.g., via network/internet connection) for communication between the at least one remote client 102 and the at least one server 108.

Each remote client 102 contains (or has access to software stored on the servers 108) software which queries a user's needs for a future purchase of equipment and/or analyzes answers to those queries using a relational database (explained in greater detail below). After receipt of the answers, the remote client 102 subsequently transmits those answers to at least one of the servers 108. Each of the servers 108 updates each other. Transmission can occur at predetermined intervals (e.g., every few days); every time the remote client 102 is in communication with the server 108; and/or by initiation from a user utilizing one of the remote clients 102 or one of the servers 108.

The servers 108 receive the answers and update a relational database to include all of the answers received from the various remote clients 102. The servers 108 share the information with each other so that the information all of the servers have the same information. When a remote client 102 communicates with one of the servers 108, a relational database in the remote client 102 is updated to include information regarding other client answers stored in the server 108 (e.g., answers to the queries of other clients) and not already stored in the relational database in the remote client 102. For example, when a user utilizes one of the remote clients 102 to enter the answers for a client, those answers are stored in the relational database of the remote client 102 and subsequently transmitted towards at least one of the servers 108. During communication with the remote client 102, the server 108 receives and stores client answers not previously stored relational database in the server 108. The answers are shared with the other servers 108. In addition, during communication with the remote client 102, one of the servers 108 transmits information to the remote client 102 that is not already stored in the relational database of the remote client 102.

For example, the software queries a user's needs for the purchase of security equipment. After receiving answers to the queries, each of the servers 108 receives and stores data from the remote clients 102 via the network connection 104. Upon the occurrence of an event, the event (and data associated therewith) is stored in the memory of the remote client 102 for subsequent transmission towards the server 108. The event data includes, but is not limited to, an event type and other data associated with the event.

In various embodiments, critical questions are provided for a user to answer. The questions have already been pre-populated with answers. Each pre-populated answer is an average of all of the previous answers by other users of that question.

A user can however alter any of the answer(s) when applicable. In various embodiments, the effect of the user's answer alteration(s) can be viewed in real time. For example, a bar representing the average answers can move in accordance with the current user's answer to show the effect of the current user's answer on the overall average. By answering the questions (and altering the answers when necessary), a more accurate estimate of the user's actual costs and potential savings when purchasing and installing equipment (e.g., security hardware and/or software). One of the technical effects associated herewith is a justification (or the lack thereof) for spending an amount for equipment.

For illustrative purposes only, aspects of this disclosure are described as using security equipment. However, that description is not intended in any way to limit the scope of this disclosure. For example, in various other embodiments, the equipment can be any equipment upon which a return-on investment analysis can be performed prior to the purchase of that equipment. It is noted, that the return-on-investment analysis includes, but is not limited to, a use of questions pre-populated with answers, the current user's answers, and answers of similarly situated users.

In various embodiments, there are about 122 questions having pre-populated answers. Initially, specialists (e.g., sales person(s), product managers, and/or others who specialize in the equipment) create the questions. For example, queries can made regarding: the cost of a “slip and fall;” litigation costs; the different types of litigation. When information from a different user (e.g., a different company or company location), the information is populated into a local database (e.g., in a laptop or other portable device). At a subsequent time, the device is in communication with a server(s) where information from other users is stored. While in communication, the server(s) and device transmit user information toward each other to update the device database and the server(s) database. As a result, all of the databases acquire and share information from all of the users. With more information, a more accurate analysis is obtained. One of the benefits of the material disclosed herein is that by virtue of the customer changing weighting of the average values (i.e., by entering that client's data) the customer provides notification, to a salesperson, of what is important to that customer. For example, if the customer's answer regarding a question regarding a feature deviates (e.g., indicating a lower value than the average) from the average, then the customer is notifying the salesperson that that feature is not as important to the customer. This notification provides an indication where the salesperson should spend their time presenting (e.g., selling) benefits that address what is important to the customer.

Subsequent analysis takes into account quantification of an attorney(s) billable hours; and employee time and wages. The questions can be divided into multiple categories (e.g., six categories). An additional category can be added for all items that do not fall within the other categories. After the questions are formulated a cost structure can be created. When formulating the cost structure broad questions are asked. A determination is made regarding all (or substantially all) of the inputs needed to calculate an amount asked in the broad question (i.e., an equation is used to address the broad question). When an event has occurred (or will occur) a query is made regarding the effect(s) (or potential effect(s)) (e.g., potential lawsuit(s) or stoppage of business). The equations can include, but not limited to, actuarial tables, risk tables, and Monte Carlo simulations. The questions presented to the user prioritize what is important to the user based upon the user's perception of what is important. Based upon the user's prioritization, an analysis can be performed and results presented in various forms (e.g., as a graphical pie chart(s) and/or spreadsheet(s)). In short, one of the benefits associated herewith is an ability to quantify cost(s) associated with an event (e.g., a robbery) and purchase (and/or installation) of equipment (e.g., security equipment); and justify (or not justify) purchase and/or installation of the equipment.

Further, in various embodiments, products from one manufacturer can be benchmarked against similar products from another manufacturer. For example, the benchmark can be the purchase price, installation, and/or product training time of a product by one manufacturer against that of another manufacturer.

In yet other embodiments, the material disclosed herein can be used to identify trends. For example, the frequency of alarms that occur in a certain customer class/segment (e.g., hospitals or car dealerships) can be analyzed to decide how to allocate resources.

In various embodiments, statistics (e.g., crime statistics, actuarial tables, and/or vertical market data (e.g., healthcare or education), and the like) are acquired by geographical location (e.g., by zip code). Based upon the user's answers, a database(s) can be accessed to bring more information to the analysis to enable a more accurate analysis of the user's needs.

FIG. 2 depicts an illustrative embodiment of a method 200 in accordance with aspects disclosed herein. The method 200 begins at step 202 and proceeds towards step 204.

At step 204, a user enters responses to general questions regarding a business entity. The responses to these general questions allow classification of the business entity. For example, a hospital may have different needs than a factory. Because these entities can have different needs they can be classified differently. Because the entities are classified differently, questions presented later in the analysis can have different populated answers.

Tables 1, 2, and 3 depict general questions provided, in part, to categorize a business entity, business concerns, and elicit general business data in accordance with aspects disclosed herein.

TABLE 1

Date:
Company Name:
Facility Type:
Number of Buildings Being
Considered in Analysis:
Address:
Zip Code:
City:
State:
Contact Name:
Email:

Current System Architecture

| | |
|---|---|
| System Type: | |
| Systems Under Consideration | |
| Current Suppliers: | 1) |
| | 2) |
| | 3) |
| | 4) |
| | 5) |
| Estimated System Age (Yrs.) | |

TABLE 2
General Questions

| | |
|---|---|
| How many employees are there in your company? | 6 |
| What is the company's average turnover rate? (%) | 12% |
| What is the total spent on your security system each year? | $70,000.00 |
| What is your hourly cost for a security officer? | $30.00 |
| (salary + benefits) | |
| What is your hourly cost for an administrator? | $60.00 |
| (salary + benefits) | |
| What is your hourly cost for an IT professional? | $50.00 |
| (salary + benefits) | |
| What is your hourly cost for an employee? | $50.00 |
| (salary + benefits) | |
| What is the hourly labor rate your vendors charge? | $85.00 |
| How many security officers do you employ? | 10 |
| What is the turnover rate of security officers per year? (%) | 40% |
| What is the hourly cost for an investigator? | $50.00 |
| (salary + benefits) | |
| What is the hourly cost for director/manager of security? | $200.00 |
| (salary + benefits) | |
| How many disparate security systems do you operate? | 1 |

TABLE 3

| Which issues are most important to you? | Estimated Annual Cost |
|---|---|
| Reduce losses from theft, vandalism, | $330,550.00 |
| employee assaults or litigation | |
| Reduce your security training and system | $8,065.00 |
| administrative costs | |
| Improve your alarm response and reduce your | $604,360.00 |
| security monitoring costs | |
| Improve database interactivity and badging | $493.00 |
| Improve security system reliability | $174.00 |
| Optimize IT deployment of security system | $256.00 |

Table 4 depicts exemplary questions provided, in part, to monetarily quantify losses incurred by the business entity in accordance with aspects disclosed herein.

TABLE 4
REDUCE LOSSES

| Have any of your staff or customers been assaulted in the last year? | |
|---|---|
| How many instances? | 5 |
| What was the cost of the company for each instance? | 0 |
| How long did it take to investigate? | 10 |
| How many security officers did you use to investigate? | 1 |
| What is the impact on insurance rate per month? | 0 |
| Cash losses from assaults | |
| Estimated productivity losses | $2,500.00 |
| One year estimated losses | $2,500.00 |
| Have you experienced any theft in the last year? | |
| How many instances? | 25 |
| What is the value of stolen assets? | 750 |
| How long did it take to investigate? | 4 |
| How many security officers did you use to investigate? | 1 |
| What is the impact on insurance rate per month? | 200 |
| Cash losses from theft | $21,150.00 |
| Estimated productivity losses | $3,000.00 |
| One year estimated losses | $24,150.00 |
| Have you been unfairly exposed to any personal injury or HR related lawsuits in the | |
| last year? | |
| How many instances? | 5 |
| What was your cash cost in legal fees? (avg. $ per instance) | $50,000.00 |
| What was your cash cost to settle “nuisance claims?” (avg. $ per instance) | $10,000.00 |
| How many employees have been impacted during the investigation and resolution process? | 3 |
| Number of hours per employee involved | 2 |
| What is the impact on insurance rate per month? ($ per month) | 200 |
| Cash expense from litigation | $302,400.00 |
| Estimated productivity losses | $1,500.00 |
| One year estimated losses | $303,900.00 |
| Have you been the victim of vandalism in the last year? | |
| How many instances? | 0 |
| What was your cash cost to repair each? | $100.00 |
| How long did it take to investigate? | 2 |
| How many people did you use to investigate? | 2 |
| What is the impact on insurance rate per month? ($ per month) | 0 |
| Cash losses from vandalism | $ |
| Estimated productivity losses | $ |
| One year estimated losses | $ |
| Have you been the victim of theft, vandalism and/or lawsuit that has affected your | |
| ability to conduct business? | |
| How many times has that occurred in the last year? | 0 |
| For how many hours did it affect your business? | 1 |
| By what percent did the event impact your capability to conduct business? | 20% |
| What is the cost to operate that part of your business for one year? | $25,000.00 |
| What is your estimate of revenue per hour generated in that business per hour? | $25,000.00 |
| One year estimated productivity losses | $ |
| Have you ever had a “front page” security incident that measurably affected your | |
| business? | |
| What was the financial impact per month? | 0 |
| For how many months did you notice this financial impact? | 6 |
| What is the possibility of another “front page” security incident in the next year? | 2% |
| One year estimated cash losses | $ Lost per year |
| Total Estimated Productivity Losses | $7,000.00 |
| Total Estimated Cash Losses | $323,550.00 |
| Total Losses | $330,550.00 |

Table 5 depicts exemplary questions provided, in part, to quantify resources (e.g., monetary) expended in association with security personnel in accordance with aspects disclosed herein.

TABLE 5
Training and administration

| | |
|---|---|
| # of new security officers per year | 3 |
| Do you have a formal training program for security officers? | |
| What % of officers do you train on each video/access system? | 50% |
| How many total hours are spent in training on each security system? | 5 |
| What is the per-person tuition for outside training? | 0 |
| What are travel costs for outside training? | 0 |
| If in-house, what is the cost per-hour of instructors (include salary + benefits)? | 60 |
| How long does it take to train each officer on facility layout and location | 40 |
| of security components? | |
| Do you have annual construction charges to your infrastructure | |
| requiring changes in your security system? | |
| How many times does this happen per year? | 2 |
| How many hours does it take to rebuild alarm graphics? | 2 |
| How long does it take officers to relearn where the access control and | 5 |
| video points are located? | |
| Cash out of pocket | $340/year |
| Productivity costs | $7,725/year |
| Total training costs | $8,065/year |
| Estimated training tuition & travel costs saved per officer | 0 |
| What is the new number of hours spent in security system training? | 2 |
| What is the new average # of hours to rebuild alarm graphics? | 2 |
| What is the new average # of hours for officers to learn the facility layout | 20 |
| and location of security components? | |
| What is the new average # of hours for officers to relearn access control | 2 |
| and video points? | |

At step 206, at least one issue is selected. Selection of an issue(s), in part, focuses current costs incurred by the business entity and/or determining which issues the business entity considers more important. Thereafter, the method 200 proceeds to step 208.

At step 208, a user advances through a series of questions/computer screen shots. Some of the questions are already populated with an answer. The user can erase an answer already present and insert a different answer; or acquiesce to the answer already present.

TABLE 6

| Alarm & Monitoring | Minimum |
|---|---|
| Do you frequently experience and respond to false alarms? | |
| How often does this occur each week? | 3 |
| How many security officers respond to each alarm event? | 1 |
| How long does it take for a security officer to respond to an | 10 |
| alarm? (minutes) | |
| How long does it take for a security officer to investigate | 30 |
| and return to station/rounds? (minutes) | |
| Do you employ external alarm monitoring companies? | |
| For how many facilities do you use an external monitoring | 1 |
| company? | |
| What is the cost of each per month? (dollars) | 100 |
| How often does an external monitoring force respond to | 20 |
| false alarms (fire, police, external, etc.)? | |
| What is the charge for each false alarm (fire, police, | 250 |
| external monitoring company)? | |
| Do you spend time looking for events that might be | |
| captured on video? | |
| How many incidents do you investigate per week? | 10 |
| What % of those incidents requires video review? | 76% |
| What is the length of time to isolate each video event? | 90 |
| Do your security officers spend time locking/ | |
| unlocking doors? | |
| How many instances per week do they perform this task? | 20 |
| How long does it take per instance? | 20 |
| Have you missed a security event because of monitoring | |
| capability (theft, assault, other)? | |
| Number of security events? | 2 |
| What was the economic impact per event? | $250,000.00 |
| Cash out-of-pocket (per year) | $61,200.00 |
| Productivity cost (per year) | $43,160.00 |
| Risk cost (per year) | $500,000.00 |

Table 6, above, includes exemplary questions provided, in part, to quantify monetary resources expended due to alarms and monitoring thereof in accordance with aspects disclosed herein.

Table 7, below, includes exemplary questions provided, in part, to quantify monetary resources expended due to maintaining a database in accordance with aspects disclosed herein.

TABLE 7
Database & Reporting

| | |
|---|---|
| Do you use integrated reporting capability from your | |
| aces control database? | |
| How many reports do you run monthly from your | 1 (# per month) |
| security system? | |
| How long does each report take to compile? | 1 (# per month) |
| # of new employees per year | 300 (# new employees) |
| # of databases with employee information (including | 1 (# of databases) |
| HR databases) | |
| What is the length of time to enter each employee into | 1 (#of minutes) |
| access control system? | |
| What is the hard cost to issue 1 employee ID/access | 1 ($ per credential) |
| credential? | |
| What % of your employees has multiple access/ID | 1% (% credentials) |
| credentials? | |
| Number of ID credentials held | 1 (# of credentials) |
| | % credentials |
| % of credentials returned upon employee's departure | 1% returned |
| How many minutes does it take to remove one employee | 1 (# of minutes) |
| from the security database? | |
| What is the number of days between an employee's | 1 (# of days) |
| departure and until you receive notification of their | |
| departure? | |
| Cash out-of-pocket | $0 per year |
| Estimated productivity cost | $493 per year |
| Total database efficiency costs | $493 total costs |

TABLE 8

| System Reliability | |
|---|---|
| Have you ever experienced a security outage that | |
| limited your ability to protect your facilities? | |
| How many times has this happened? | 1 (# of times per year) |
| How long does it take to restore the system? | 1 (# of hours) |
| How many security personnel hours are required | 1 (# of hours) |
| to restore database? | |
| How many IT personnel hours are required to | 1 (# of hours) |
| rebuild server(s)? | |
| How many vendor hours are charged to restore | 1 (# of hours) |
| the system? | |
| What additional expediting costs do you incur to | 1 ($ per instance) |
| ship replacement parts? | |
| Have you ever hired additional security officers to | YES |
| secure the facility during an outage? | |
| How many additional security officers did it take | 1 (# of officers) |
| to secure the facility? | |
| What is the cost of an outside security officer per | 1 ($ per hour) |
| hour? | |
| In what percent of the instances did you hire | 1% (% of instances) |
| outside security officers? | |
| Do you experience network slowdowns from data | |
| coming from the security system? | |
| How often does this happen per week? | 1 (# of instances) |
| For how long does the slowdown occur? | 1 (# of minutes) |
| How many employees/users does this effect? | 1 (# of users) |
| | % less than normal |
| How much does this slow down the effectiveness | 1% productivity |
| of your employees (% effect)? | |
| Cash out-of-pocket | $86 per year |
| Estimated productivity costs | $88 per year |
| Total system efficiency cost | $174 total cost |

Table 8, above, includes exemplary questions provided, in part, to quantify monetary resources expended due to system reliability in accordance with aspects disclosed herein.

Table 9, below, includes exemplary questions provided, in part, to quantify monetary resources expended due to equipment deployment in accordance with aspects disclosed herein.

TABLE 9

| Optimize IT Deployment | |
|---|---|
| Do you utilize multiple standalone security systems? | |
| How many disparate security systems do you have | 2 (# of systems) |
| today? | |
| How many years do servers last? | 2 (# of years) |
| What portion of your software requires annual | 2% (% |
| maintenance & upgrades? | upgraded) |
| What is the total cost for a new server? | 2$ each |
| How many hours do IT system administrators, for | # of hours per |
| each system, require? | week |
| What is the annual cost for supporting the | 2 ($ per year) |
| infrastructure for each system? | |
| What is the annual amount required for hardware and | 2 ($ per year) |
| maintenance for each system? | |
| What is the total cost of maintaining external storage | 2 ($ per year) |
| for each system? | |
| How many system control centers do you have? | 2 (# of centers) |
| What are system monitoring costs for each control | 2 ($ per year) |
| center? | |
| How many badging stations do you have? | 2 (# of stations) |
| What is the cost for each badge printer? | |
| What is the cost for each print cartridge? | $2 per cartridge |
| What is the life of a badge printer? | 2 (# of years) |
| What is the life of each print cartridge? | 2 (# of badges) |
| Cash out-of-pocket | $16 per year |
| Estimated productivity cost | $240 per year |
| Total system cost | $256 total cost |

After step 208, in various embodiments, the method 200 proceeds to and ends at step 210. In other embodiments, after step 208, the method 200 proceeds to optional step 212.

Table 10, below, includes exemplary requests for, in part, monetary data regarding other costs associated with the business entity (e.g., other security costs) in accordance with aspects disclosed herein.

TABLE 10

| Other Costs | |
|---|---|
| Please classify accordingly any other costs you might have | |
| incurred regarding your security system | |
| Cash Expenses | $100,000.00 |
| Productivity Expenses | $100,000.00 |
| Potential Risk Expenses | $100,000.00 |

Table 11 includes a question designed, in part, to elicit a proposed spending budget by the business entity in accordance with aspects disclosed herein.

TABLE 11

| Estimated Investment for the Security Solution | |
|---|---|
| What is the estimated investment to be made for | $100,000.00 |
| the proposed security solution? | |

Tables 12, 13, and 14, respectively include loss analysis (i.e., a return-on-investment) in accordance with aspects disclosed herein.

TABLE 12
Savings Estimate Through Loss Reduction

| | |
|---|---|
| To what extent would the capabilities of Facility | |
| Commander improve your ability to prevent these losses? | |
| System Availability | 50% % improvement |
| Video Management | 50% % improvement |
| Graphics Management | 50% % improvement |
| GUI Savings | 50% % improvement |
| SQL Database | 50% % improvement |
| System Integration | 50% % improvement |
| One year estimated losses | $165,275--Total estimated losses |

Savings Estimate Through Training & Administration

| | |
|---|---|
| ROI Estimate | |
| Estimated training tuition & travel cost saved per officer | 0 ($ per officer) |
| What is the new number of hours spent in security system | 2 (# of hours per |
| training? | person) |
| What is the new average # of hours to rebuild alarm | 2 (# of hours per |
| graphics? | person) |
| What is the new average # of hours for officers to learn the | 20 (# of hours per |
| facility layout and location of security components? | person) |
| What is the new average # of hours for officers to relearn | 2 (# of hours per |
| access control and video points? | person) |
| Total estimated savings | $3,870.00 $ per year |
| | 100% % productivity |
| | 0.00% % cash |

At optional step 212, a return on investment for the business entity is calculated. Thereafter, the method 200 proceeds to optional step 214. At optional step 214, the return on investment for the business entity is saved, displayed, and/or printed. The data on the business entity is combined with the previously populated answers to form a new population. Because the new population contains data from more sources than the previous population, the new population is more accurate than the previous population. In various embodiments, the new population (or in other embodiments, the answers of the business entity) is transmitted towards the server (that in turn transmits it to other devices that do not have this information).

TABLE 13
Savings Estimate Through Alarm and Monitoring

ROI Estimate
Facility Commander offers easy alarm monitoring showing the operator status,
location and level of severity-all at a glance. The video management console
supports a quick launch feature for on-screen video playback, automatic live video
pop-up and video event tagging. These features allow you to reduce monitoring
costs, reduce false alarms, improves response time and investigation time.

| | |
|---|---|
| What is the new number of facilities for outsourcing | 1 (# of facilities) |
| monitoring? | |
| Estimate the new number of false alarms responded to by | 1 (# per week) |
| security officers. | |
| What is the estimated new number of false alarms | 1 (# per month) |
| responded to by outside security? | |
| Estimate the new length of time required to isolate each | 5 (# of minutes) |
| event on video. | |
| Estimate the new number of minutes to lock/unlock doors | 1 (# of minutes) |
| Estimate the number of previously missed events you'd | 4 (# of events per |
| detect. | month |
| What is the % improvement in locating an alarm o access | 75% (% improvement |
| an event? | in response) |
| Estimated savings | $586,329 ($ saved per year) |
| | 10% (% cash) |
| | 5% (% productivity) |
| | 85% (% risk) |

Savings Estimate Through Data and Badging

Enhanced imaging and credentialing is incorporated to facilitate centralization of the
enrollment and card issuing process. Further SQL report writing capability can
integrate security databases with other company databases housing employee
information. This capability reduces administrative costs associated with card
issuance and other security events.

| | |
|---|---|
| Estimate new number of databases with employee | 1 (# of databases) |
| information. | |
| Estimate the number of minutes to compile each weekly | 1 (# of minutes each) |
| report | |
| Estimated cost savings | $1 ($ saved per year) |
| | 0% (% cash) |
| | 100% (% productivity) |

TABLE 14
Savings Estimate Through System Reliability
After implementing a solution:

| | |
|---|---|
| How many security outages do you estimate per | 1 (# of times per year) |
| year in the future? | |
| How much less time do you think it will take to | 100% (% reduction) |
| restore the system? | |
| How many fewer times per week do you expect | 100% (% reduction) |
| network slowdowns caused by a security system? | |
| Estimated cost savings | $1 ($ saved per year) |
| | 0% (% cash) |
| | 100% (% productivity) |

Savings Estimate Through Optimization of IT

| | |
|---|---|
| How many servers will you support after | 1 (# of servers) |
| centralization? | |
| How many system control centers after | 1 ($ per year) |
| centralization? | |
| What are the system monitoring costs for each | 1 ($ per year) |
| control center after centralization? | |
| How many badging centers after centralization? | 1 (# of centers) |
| Total IT optimization savings | $129 ($ per year) |
| | 7% (% cash) |
| | 93% (% productivity) |

Savings Estimate Through Improvements in Other Costs

| | |
|---|---|
| Cash Expenses | 50% (% improvement) |
| Productivity Expenses | 50% (% improvement) |
| Potential Risk Expenses | 50% (% improvement) |

FIG. 3 depicts another embodiment of a method 300 in accordance with aspects disclosed herein. The method 300, in various embodiments, uses such tools as cluster analysis, multivariate analysis, Monte Carlo simulations, and expected value analysis to determine the return on investment. In various embodiments, a competitive benchmarking (e.g., using beta testing, side-by-side comparison, and/or a return on investment survey) is performed to compare products by the same manufacturer; and/or products by different manufacturers. The method 300 starts at step 302 and proceeds towards step 304.

At step 304, a user answers general company questions. Step 304 includes steps 306, 308, 310, 312, 314, 316, and 318. Examples of general company questions are provided in the tables below. At steps 306 and 308, a user's address and other demographic data is inserted. At step 310, a user's current configuration (i.e., the user's currently installed equipment) is inserted. Steps 306, 308, and 310 generally query “who is the organization?” “where is the organization?” and “what equipment (e.g., hardware and/or software) does the organization currently have?”

At step 312, the data acquired at step 306 is used to determine whether any actuarial data is available. For example, if actuarial data is present for a zip code acquired at step 306, then that actuarial data can provide data that the customer can use (e.g., in the acquired zip code the customer can expect a certain crime/theft rate).

At step 314, a determination is made as to the segmentation of the organization (e.g., whether it is a hospital, restaurant, or car dealership). For different segments, there may be different quantifiable risks.

At step 316, competitive benchmarking is located for the identified segment and is self-populating (i.e., automatically displayed where appropriate) with pre-populated answers. For example, the answers presented in Tables 4-12 can be self-populating. The competitive benchmarking data is data previously acquired from other customers. At step 316, the data acquired by the current customer is compared to the data acquired from the other customers for that segment.

At step 318, the competitive benchmarking data and the data for the current customer is analyzed. When the current customer makes changes to the self-populating answers then a recalculation of that customer's needs is performed. The analysis can include, but is not limited to, a cluster analysis, a multivariate analysis, Monte Carlo simulations, and an expected value analysis. By performing the recalculation, a better analysis of the customer's needs is provided. After step 318, the method 300 proceeds towards step 320.

At step 320, the data (e.g., the appropriate category, geographical data, and user answers) are used to automatically generate a ROI cost analysis. The output of step 318, the customer's costs, and the relationship of the ROI are used to perform the ROI cost analysis. Thereafter, the method 300 proceeds towards step 322.

At step 322, the user prioritizes a list of items. After step 322, the method 300 proceeds towards step 324.

At step 324, answers that are related to user priority change in accordance with the priority selections made at step 322. The changes are stored in an internal database 326. During (or in other embodiments after) transmission of the changes towards the internal database 326, the method 300 proceeds towards step 328.

At step 328, an estimate of a solution to the user's equipment (i.e., hardware purchase costs and implementation thereof) needs is provided. To assist in the estimate, an equipment database 330 is accessed to obtain price estimate(s) of the desired equipment or to determine which equipment falls within the user's budget. Thereafter, the method 300 proceeds towards step 332.

At step 332, information acquired from the equipment database 330 is used to calculate a ROI (operating costs and the risks averted). The ROI analysis is used at step 334. At step 334, an analysis is performed which includes, but is not limited to, an internal rate of return (“IRR”), a net present value (“NPV”), and economic value added (“EVA”) to determine a payback period for the investment. After step 332, the method 300 proceeds towards step 336.

At step 336, an analysis ROI is performed which utilizes the results obtained at steps 328 and 332.

At step 338, an output of the ROI analysis (e.g., via a print out, email, and/or on a computer display) is presented to the user. Thereafter, the method 300 proceeds towards and ends at step 340.

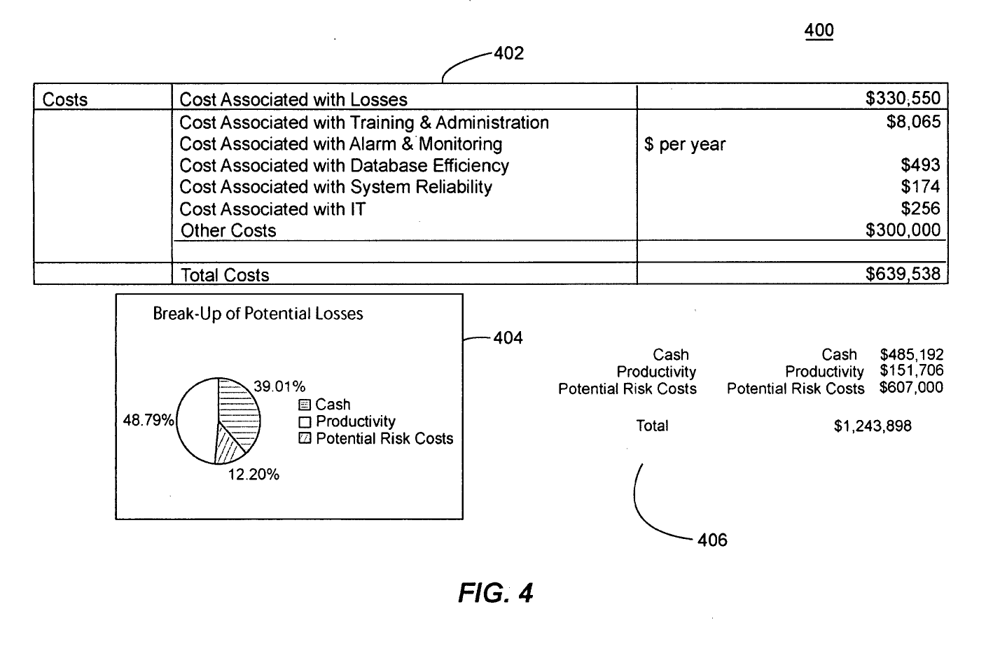

FIG. 4 depicts a computer screen shot of a loss analysis derived from a combination of the populated answers and answers replaced on behalf of the business entity in accordance with aspects disclosed herein.

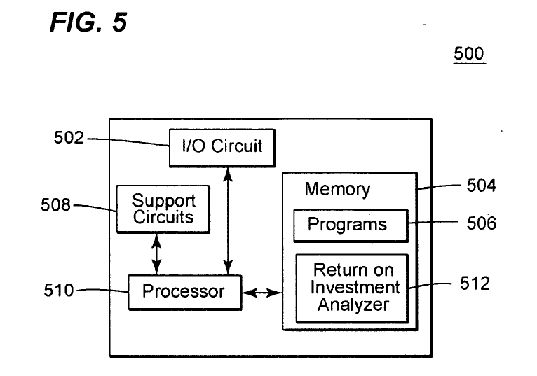

FIG. 5 depicts a high-level block diagram of a general-purpose computer architecture 500 for performing an embodiment of the invention. For example, the general-purpose computer 500 is suitable for use in performing the methods of FIGS. 2 and/or 3. The general-purpose computer of FIG. 5 includes a processor 510 as well as a memory 504 for storing control programs and the like. In various embodiments, memory 504 also includes programs (e.g., depicted as a “return on investment analyzer” 512) for performing the methods 200 and/or 300. The processor 510 cooperates with conventional support circuitry 508 such as power supplies, clock circuits, cache memory and the like as well as circuits that assist in executing the software routines 506 stored in the memory 504. As such, it is contemplated that some of the process steps discussed herein as software processes may be loaded from a storage device (e.g., an optical drive, floppy drive, disk drive, etc.) and implemented within the memory 504 and operated by the processor 510. Thus, in various embodiments invention, can be stored on a computer readable medium. For example, any/all of the methods 200 and/or 300 can be stored on computer-readable media as a plurality of instructions which, when executed by a processor, cause the processor the processor to perform any step (or steps) indicated in the methods 200 and/or 300. The general-purpose computer 500 also contains input-output circuitry 502 that forms an interface between the various functional elements communicating with the general-purpose computer 500.

Although FIG. 5 depicts a general-purpose computer 500 that is programmed to perform various control functions in accordance with the present invention, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein. In addition, although one general-purpose computer 500 is depicted, that depiction is for brevity only. It is appreciated that the methods 200 and/or 300 can be in separate computers.

While the foregoing is directed to embodiments of the present invention, other and further embodiments of the invention may be devised without departing from the basic scope thereof, and the scope thereof is determined by the claims that follow.

We claim:

1. A method comprising:
classifying a business entity;
answering questions pre-populated with answers and replacing said pre-populated answers with different answers when said pre-populated answers are incorrect; and
performing at least one of a return-on-investment (“ROI”) analysis of equipment prior to a purchase of said equipment, generating an output of said analysis, storing a result of said answered questions, and transmitting said answered questions towards a server.

2. The method of claim 1, wherein said ROI analysis comprises:
acquiring costs for at least one piece of first equipment from a first provider and for at least one piece of second equipment from a second provider;
comparing said costs of said at least one piece of first equipment with said at least one piece of second equipment.

3. The method of claim 1, wherein said ROI analysis comprises:
estimating costs associated with a user's current equipment.

4. The method of claim 1, wherein said ROI analysis comprises:
estimating costs associated with at least one of an equipment purchase, an implementation of said equipment, operating costs associated with said equipment, and risks/benefits associated with said equipment.

5. The method of claim 1, wherein said ROI analysis comprises:
altering a classification of a user's resources based upon a priority selection.

6. The method of claim 1, further comprising:
receiving, from said server, data updates; and
storing said data updates in a database.

7. A computer-readable medium having stored thereon a plurality of instructions, the plurality of instructions including instructions which, when executed by a processor, cause the processor to perform the steps comprising:
classifying a business entity;
answering questions pre-populated with answers and replacing said pre-populated answers with different answers when said pre-populated answers are incorrect; and
performing at least one of a return-on-investment (“ROI”) analysis of equipment prior to a purchase of said equipment, generating an output of said analysis, storing a result of said answered questions, and transmitting said answered questions towards a server.

8. The computer-readable medium of claim 7, wherein said ROI analysis comprises:
acquiring costs for at least one piece of first equipment from a first provider and for at least one piece of second equipment from a second provider;
comparing said costs of said at least one piece of first equipment with said at least one piece of second equipment.

9. The computer-readable medium of claim 7, wherein said ROI analysis comprises:
estimating costs associated with a user's current equipment.

10. The computer-readable medium of claim 7, wherein said ROI analysis comprises:
estimating costs associated with at least one of an equipment purchase, an implementation of said equipment, operating costs associated with said equipment, and risks/benefits associated with said equipment.

11. The computer-readable medium of claim 7, wherein said ROI analysis comprises:
altering a classification of a user's resources based upon a priority selection.

12. The computer-readable medium of claim 7, further comprising:
receiving, from said server, data updates; and
storing said data updates in a database, wherein said database comprises pre-populated answers.
